(19) United States
(12) Patent Application Publication
(10) Pub. No.: US 2021/0146613 A1
(43) Pub. Date: May 20, 2021

(54) Systems and Methods for Solidification Rate Control During Additive Manufacturing

(71) Applicant: DMG MORI ADVANCED SOLUTIONS, Hoffman Estates, IL (US)

(72) Inventors: Gregory A. Hyatt, South Barrington, IL (US); Jennifer L. Bennett, Gilberts, IL (US)

(73) Assignee: DMG MORI ADVANCED SOLUTIONS, Hoffman Estates, IL (US)

(21) Appl. No.: 16/620,269

(22) PCT Filed: Jun. 6, 2018
(86) PCT No.: PCT/US18/36278

§ 371 Date: Dec. 6, 2019

Related U.S. Application Data
(60) Provisional application No. 62/515,877, filed on Jun. 6, 2017.

(51) Int. Cl. B29C 64/153; B29C 64/393; B29C 64/209; B33Y 50/02; B29C 64/245; B29C 64/268

(52) U.S. Cl. CPC B29C 64/153; B29C 64/393; B29C 64/209; B33Y 10/00; B29C 64/245; B29C 64/268; B33Y 50/02

(57) ABSTRACT

Apparatus and methods of forming a three-dimensional build object on a substrate (204) include directing an energy beam (202) onto the substrate (204) to form a melt pool (308), wherein the energy beam (202) traverses the substrate (204) in a process direction (322) at a process speed, depositing additive material into the melt pool (308), and measuring energy emitted by the melt pool (308). A thermal signature of the melt pool (308) is determined based on the measured energy. The method further includes identifying a liquidus region (332) of the melt pool (308), a solidus region (334) surrounding the melt pool (308), and a transitional region (336) of the melt pool (308) based on the thermal signature. A physical parameter of the transitional region (336) of the melt pool (308) is quantified, an actual solidification rate is determined based on a comparison of the physical parameter of the transitional region (336) and the process speed, and a process parameter is adjusted based on the actual solidification rate.

### BACKGROUND

### Technical Field

The present disclosure generally relates to additive manufacturing systems and methods and, more particularly, to systems and methods for controlling solidification rate during additive manufacturing.

### Description of the Related Art

Additive manufacturing control systems exist for monitoring melt pool size and/or melt pool temperature. Such systems typically estimate melt pool temperature using a pyrometer, photodiode, infrared (IR) camera, or charge-coupled device (CCD) camera, and attenuate laser power based on the estimated temperature.

Additive manufacturing systems and processes are generally known which create successive layers of material to form a three-dimensional object, referred to herein as a “build object.” Additive manufacturing techniques include, but are not limited to, powder bed fusion processes such as laser sintering, laser melting, and electron beam melting; direct energy deposition processes such as laser engineered net shaping direct metal/material deposition, and laser cladding; material extrusion such as fused deposition modeling; material jetting including continuous or drop on demand; binder jetting; vat polymerization; and sheet lamination including ultrasonic additive manufacturing. In some direct energy deposition processes, powder is injected from one or more nozzles into a focused beam of a laser to melt a small pool of the substrate material. Powder contacting the pool will melt to generate a deposit on the substrate.

Certain types of additive materials present particular challenges when used in a direct energy deposition process. For example, as materials cool and solidify, they may form microstructures. For some materials, the particular configuration of the microstructure formation may depend on the rate at which the material is cooled after deposition, and therefore it would be advantageous to monitor and control the solidification rate during the build process.

### SUMMARY OF THE DISCLOSURE

The systems and methods disclosed herein monitor and control the solidification rate of a melt pool by determining an apparent thermal signature of the melt pool, determining a corrected thermal signature by applying a correction factor obtained from an actual temperature of the melt pool, deriving an actual solidification rate based on the corrected thermal signature, and adjusting a process parameter based on the actual solidification rate.

According to certain aspects of this disclosure, a method of forming a three-dimensional build object on a substrate is provided that includes directing an energy beam onto the substrate to form a melt pool on the substrate, wherein the energy beam traverses the substrate in a process direction at a process speed, depositing additive material into the melt pool, and measuring energy emitted by the melt pool. A thermal signature of the melt pool is determined based on the measured energy. The method further includes identifying a liquidus region of the melt pool, a solidus region surrounding the melt pool, and a transitional region of the melt pool based on the thermal signature. A physical parameter of the transitional region of the melt pool is quantified, an actual solidification rate is determined based on a comparison of the physical parameter of the transitional region and the process speed, and a process parameter is adjusted based on the actual solidification rate.

According to additional aspects of this disclosure, which may be combined with any of the other aspects identified herein, determining the thermal signature of the melt pool includes determining an apparent thermal signature of the melt pool, and identifying the liquidus, solidus, and transitional regions includes identifying the liquidus, solidus, and transitional regions based on the apparent thermal signature of the melt pool.

According to additional aspects of this disclosure, which may be combined with any of the other aspects identified herein, determining the thermal signature of the melt pool includes determining an apparent thermal signature of the melt pool, and the method further includes determining an average actual temperature of the melt pool, calculating an average apparent temperature of the apparent thermal signature, determining a correction factor based on a comparison of the average apparent temperature and the average actual temperature, and applying the correction factor to the apparent thermal signature to obtain a corrected thermal signature of the melt pool, wherein identifying the liquidus, solidus, and transitional regions comprises identifying liquidus, solidus, and transitional regions based on the corrected thermal signature of the melt pool.

According to additional aspects of this disclosure, which may be combined with any of the other aspects identified herein, the correction factor is proportional to a difference between the average apparent temperature and the average actual temperature.

According to additional aspects of this disclosure, which may be combined with any of the other aspects identified herein, determining the average actual temperature of the melt pool includes directing a pyrometer at the melt pool.

According to additional aspects of this disclosure, which may be combined with any of the other aspects identified herein, the pyrometer is a dual-wavelength pyrometer, and determining the average actual temperature of the melt pool includes determining a first energy profile at a first wavelength, determining a second energy profile at a second wavelength, and calculating the average actual temperature based on a ratio of the first energy profile to the second energy profile.

According to additional aspects of this disclosure, which may be combined with any of the other aspects identified herein, quantifying the physical parameter of the transitional region of the melt pool includes determining a solidification distance in the process direction between the liquidus region and the solidus region.

According to additional aspects of this disclosure, which may be combined with any of the other aspects identified herein, the actual solidification rate is proportional to the solidification distance divided by the process speed.

According to additional aspects of this disclosure, which may be combined with any of the other aspects identified herein, quantifying the physical parameter of the transitional region of the melt pool comprises determining a ratio of an area of the transitional region to an area of the sum of the transitional and liquidus regions.

According to additional aspects of this disclosure, which may be combined with any of the other aspects identified herein, the actual solidification rate is proportional to the ratio divided by the process speed.

According to additional aspects of this disclosure, which may be combined with any of the other aspects identified herein, adjusting the process parameter based on the actual solidification rate includes adjusting a power level of the energy beam.

According to additional aspects of this disclosure, which may be combined with any of the other aspects identified herein, adjusting the process parameter based on the actual solidification rate includes adjusting a rate at which additive material is deposited onto the melt pool.

According to additional aspects of this disclosure, which may be combined with any of the other aspects identified herein, adjusting the process parameter based on the actual solidification rate includes adjusting the process speed.

According to additional aspects of this disclosure, which may be combined with any of the other aspects identified herein, adjusting the process parameter based on the actual solidification rate includes adjusting a power level of the energy beam, adjusting a rate at which additive material is deposited onto the melt pool, and adjusting the process speed.

According to additional aspects of this disclosure, which may be combined with any of the other aspects identified herein, measuring energy emitted by the melt pool includes directing an infrared camera at the melt pool.

According to additional aspects of this disclosure, which may be combined with any of the other aspects identified herein, an additive manufacturing apparatus is provided for forming a three-dimensional build object on a substrate. The apparatus includes an energy source configured to direct an energy beam onto the substrate to form a melt pool on the substrate, a nozzle configured to deposit additive material into the melt pool, and a camera configured to measure energy emitted by the melt pool. A controller is operatively coupled to the energy source and camera, and the controller programmed to move the energy source so that the energy beam traverses over the substrate in a process direction at a process speed, determine a thermal signature of the melt pool based on the energy of the melt pool measured by the camera, identify a liquidus region of the melt pool, a solidus region surrounding the melt pool, and an transitional region of the melt pool between the liquidus region and the solidus region based on the thermal signature, quantify a physical parameter of the transitional region of the melt pool, determine an actual solidification rate based on a comparison of the physical parameter of the transitional region and the process speed, and adjust a process parameter based on the actual solidification rate.

According to additional aspects of this disclosure, which may be combined with any of the other aspects identified herein, the controller is further programmed to determine the thermal signature of the melt pool by determining an apparent thermal signature of the melt pool, and identify the liquidus, solidus, and transitional regions based on the apparent thermal signature of the melt pool.

According to additional aspects of this disclosure, which may be combined with any of the other aspects identified herein, the apparatus further includes a pyrometer configured to measure an average actual temperature of the melt pool.

According to additional aspects of this disclosure, which may be combined with any of the other aspects identified herein, the controller is further programmed to determine the thermal signature of the melt pool by determining an apparent thermal signature of the melt pool, calculate an average apparent temperature of the apparent thermal signature, determine a correction factor based on a comparison of the average apparent temperature and the average actual temperature, apply the correction factor to the apparent thermal signature to obtain a corrected thermal signature of the melt pool, and identify the liquidus, solidus, and transitional regions based on the corrected thermal signature of the melt pool.

According to additional aspects of this disclosure, which may be combined with any of the other aspects identified herein, the controller is further programmed to determine the correction factor as proportional to a difference between the average apparent temperature and the average actual temperature.

According to additional aspects of this disclosure, which may be combined with any of the other aspects identified herein, the pyrometer is a dual-wavelength pyrometer configured to determine a first energy profile of the melt pool at a first wavelength and to determine a second energy profile of the melt pool at a second wavelength, and the controller is further programmed to calculate the average actual temperature based on a ratio of the first energy profile to the second energy profile.

According to additional aspects of this disclosure, which may be combined with any of the other aspects identified herein, the controller is further programmed to quantify the physical parameter of the transitional region of the melt pool by determining a solidification distance in the process direction between the liquidus region and the solidus region.

According to additional aspects of this disclosure, which may be combined with any of the other aspects identified herein, the controller is further programmed to determine the actual solidification rate as proportional to the solidification distance divided by the process speed.

According to additional aspects of this disclosure, which may be combined with any of the other aspects identified herein, the controller is further programmed to quantify the physical parameter of the transitional region of the melt pool by determining a ratio of an area of the transitional region to an area of the melt pool.

According to additional aspects of this disclosure, which may be combined with any of the other aspects identified herein, the controller is further programmed to determine the actual solidification rate as proportional to the ratio divided by the process speed.

According to additional aspects of this disclosure, which may be combined with any of the other aspects identified herein, the controller is further programmed to adjust the process parameter by adjusting a power level of the energy beam.

According to additional aspects of this disclosure, which may be combined with any of the other aspects identified herein, the controller is further programmed to adjust the process parameter by adjusting a rate at which additive material is deposited onto the melt pool.

According to additional aspects of this disclosure, which may be combined with any of the other aspects identified herein, the controller is further programmed to adjust the process parameter by adjusting the process speed.

According to additional aspects of this disclosure, which may be combined with any of the other aspects identified herein, the controller is further programmed to adjust the process parameter by adjusting a power level of the energy beam, adjusting a rate at which additive material is deposited onto the melt pool, and adjusting the process speed.

According to additional aspects of this disclosure, which may be combined with any of the other aspects identified herein, the camera comprises an infrared camera

### BRIEF DESCRIPTION OF THE DRAWINGS

For a more complete understanding of the disclosed methods and apparatus, reference should be made to the embodiment illustrated in greater detail on the accompanying drawings, wherein:

FIG. 1 is a front elevation of a computer numerically controlled machine in accordance with one embodiment of the present disclosure, shown with safety doors closed.

FIG. 2 is a front elevation of a computer numerically controlled machine illustrated in FIG. 1, shown with the safety doors open.

FIG. 3 is a perspective view of certain interior components of the computer numerically controlled machine illustrated in FIGS. 1 and 2, depicting a machining spindle, a first chuck, a second chuck, and a turret.

FIG. 4 a perspective view, enlarged with respect to FIG. 3 illustrating the machining spindle and the horizontally and vertically disposed rails via which the spindle may be translated.

FIG. 5 is a side view of the first chuck, machining spindle, and turret of the machining center illustrated in FIG. 1.

FIG. 6 is a view similar to FIG. 5 but in which a machining spindle has been translated in the Y-axis.

FIG. 7 is a front view of the spindle, first chuck, and second chuck of the computer numerically controlled machine illustrated in FIG. 1, including a line depicting the permitted path of rotational movement of this spindle.

FIG. 8 is a perspective view of the second chuck illustrated in FIG. 3, enlarged with respect to FIG. 3.

FIG. 9 is a perspective view of the first chuck and turret illustrated in FIG. 2, depicting movement of the turret and turret stock in the Z-axis relative to the position of the turret in FIG. 2.

FIG. 10 is a front view of the computer numerically controlled machine of FIG. 1 with the front doors open.

FIG. 11 is a schematic illustration of a material deposition assembly.

FIG. 12 is a side elevation view of a material deposition assembly having a removable deposition head.

FIG. 13 is a side elevation view of an alternative embodiment of a material deposition assembly having a removable deposition head.

FIG. 14 is a side elevation view, in partial cross-section, of a lower processing head used in the material deposition assembly of FIG. 14.

FIG. 15 is a side elevation view of an alternative embodiment of a material deposition assembly.

FIG. 16 is a graphical illustration showing plots of temperature vs. distance of a melt pool using both a thermal camera output and a pyrometer output.

FIG. 17 is a plan view of a corrected thermal signature of a melt pool.

FIG. 18 is a block diagram illustrating a method of manufacturing a build object using an actual solidification rate.

It should be understood that the drawings are not necessarily to scale and that the disclosed embodiments are sometimes illustrated diagrammatically and in partial views. In certain instances, details which are not necessary for an understanding of the disclosed methods and apparatus or which render other details difficult to perceive may have been omitted. It should be understood, of course, that this disclosure is not limited to the particular embodiments illustrated herein.

### DETAILED DESCRIPTION

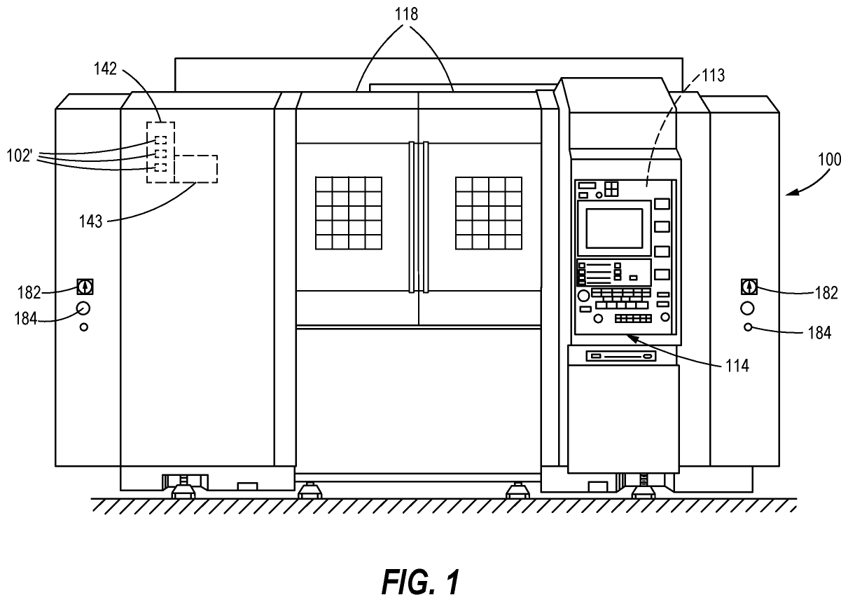

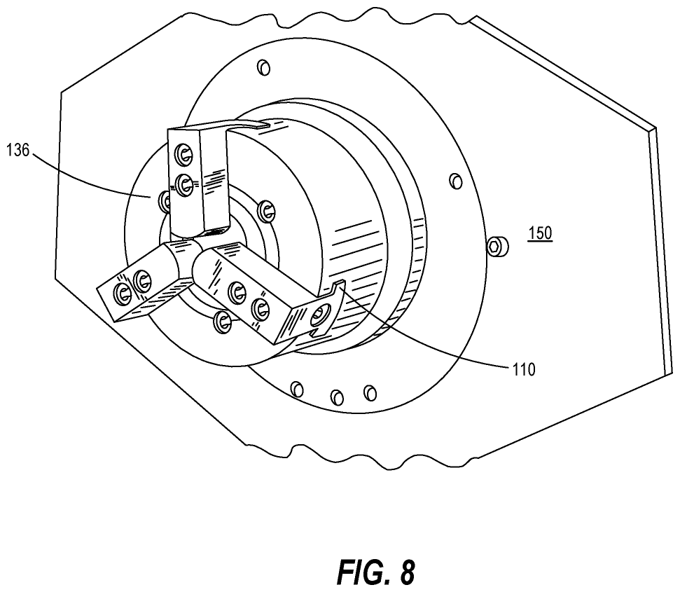

Any suitable apparatus may be employed in conjunction with the methods disclosed herein. In some embodiments, the methods are performed using a computer numerically controlled machine, illustrated generally in FIGS. 1-10. A computer numerically controlled machine is itself provided in other embodiments. The machine 100 illustrated in FIGS. 1-10 is an NT-series or LT-series machine, versions of which are available from DMG Mori. Alternatively, DMG Mori's LaserTec 65 3D (a hybrid additive and subtractive five-axis machine tool) machine tool, or other machine tools having different orientations or numbers of axes, may be used in conjunction with the apparatus and methods disclosed herein. While systems and methods disclosed herein, directed towards methods for additive manufacturing, may be performed using such machines, the contents herein are not limited to being performed on such machines.

In general, with reference to the NT-series machine illustrated in FIGS. 1-3, one suitable computer numerically controlled machine 100 has at least a first retainer and a second retainer, each of which may be a tool retainer (such as a spindle retainer associated with spindle 144 or a turret retainer associated with a turret 108) or a workpiece retainer (such as chucks 110, 112). In the embodiment illustrated in the Figures, the computer numerically controlled machine 100 is provided with a spindle 144, a turret 108, a first chuck 110, and a second chuck 112. The computer numerically controlled machine 100 also has a computer control system operatively coupled to the first retainer and to the second retainer for controlling the retainers, as described in more detail below. It is understood that in some embodiments, the computer numerically controlled machine 100 may not contain all of the above components, and in other embodiments, the computer numerically controlled machine 100 may contain additional components beyond those designated herein.

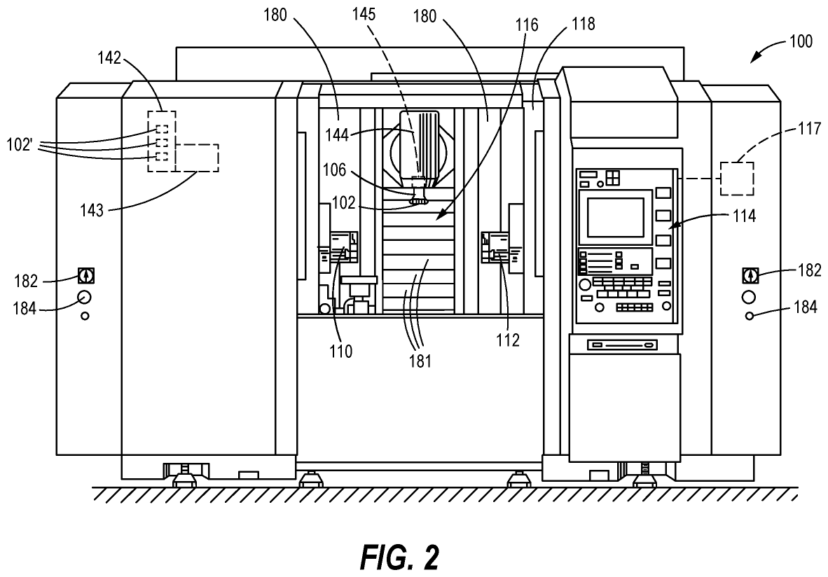

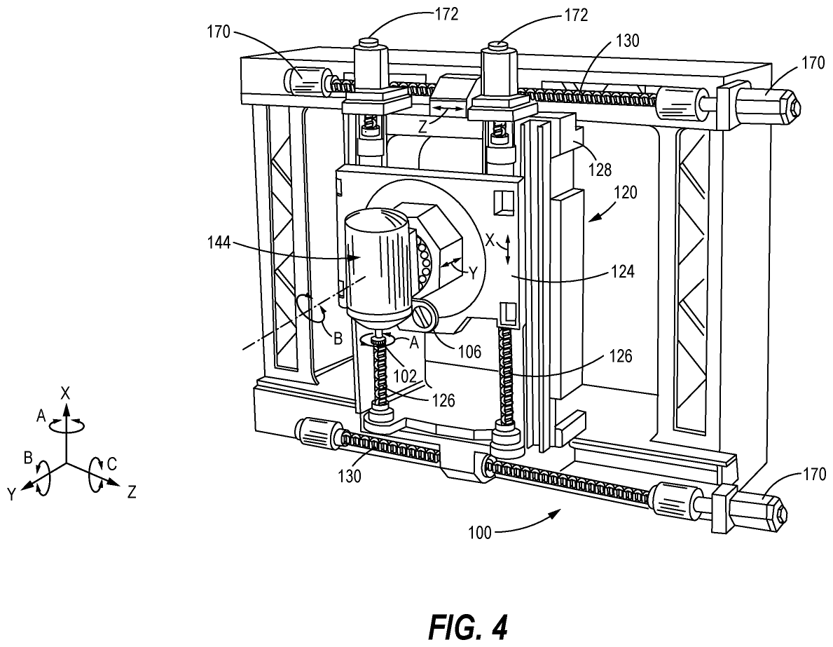

As shown in FIGS. 1 and 2, the computer numerically controlled machine 100 has a machine chamber 116 in which various operations generally take place upon a workpiece (not shown). Each of the spindle 144, the turret 108, the first chuck 110, and the second chuck 112 may be completely or partially located within the machine chamber 116. In the embodiment shown, two moveable safety doors 118 separate the user from the machine chamber 116 to prevent injury to the user or interference in the operation of the computer numerically controlled machine 100. The safety doors 118 can be opened to permit access to the machine chamber 116 as illustrated in FIG. 2. The computer numerically controlled machine 100 is described herein with respect to three orthogonally oriented linear axes (X, Y, and Z), depicted in FIG. 4 and described in greater detail below. Rotational axes about the X, Y and Z axes are connoted “A,” “B,” and “C” rotational axes respectively.

The computer numerically controlled machine 100 is provided with a computer control system 113 for controlling the various instrumentalities within the computer numerically controlled machine. In the illustrated embodiment, the machine is provided with two interlinked computer systems, a first computer system comprising a user interface system (shown generally at 114 in FIG. 1) and a second computer system (not illustrated) operatively connected to the first computer system. The second computer system directly controls the operations of the spindle, the turret, and the other instrumentalities of the machine, while the user interface 114 allows an operator to control the second computer system. Collectively, the machine control system and the user interface system, together with the various mechanisms for control of operations in the machine, may be considered a single computer control system.

The computer control system may include machine control circuitry having a central processing unit (CPU) connected to a main memory. The CPU may include any suitable processor(s), such as those made by Intel and AMD. By way of example, the CPU may include a plurality of microprocessors including a master processor, a slave processor, and a secondary or parallel processor. Machine control circuitry, as used herein, comprises any combination of hardware, software, or firmware disposed in or outside of the machine 100 that is configured to communicate with or control the transfer of data between the machine 100 and a bus, another computer, processor, device, service, or network. The machine control circuitry, and more specifically the CPU, comprises one or more controllers or processors and such one or more controllers or processors need not be disposed proximal to one another and may be located in different devices or in different locations. The machine control circuitry, and more specifically the main memory, comprises one or more memory devices which need not be disposed proximal to one another and may be located in different devices or in different locations. The machine control circuitry is operable to execute all of the various machine tool methods and other processes disclosed herein.

In some embodiments, the user operates the user interface system to impart programming to the machine; in other embodiments, programs can be loaded or transferred into the machine via external sources. It is contemplated, for instance, that programs may be loaded via a PCMCIA interface, an RS-232 interface, a universal serial bus interface (USB), or a network interface, in particular a TCP/IP network interface. In other embodiments, a machine may be controlled via conventional PLC (programmable logic controller) mechanisms (not illustrated).

As further illustrated in FIGS. 1 and 2, the computer numerically controlled machine 100 may have a tool magazine 142 and a tool changer 143. These cooperate with the spindle 144 to permit the spindle to operate with any one of multiple tools. Generally, a variety of tools may be provided; in some embodiments, multiple tools of the same type may be provided.

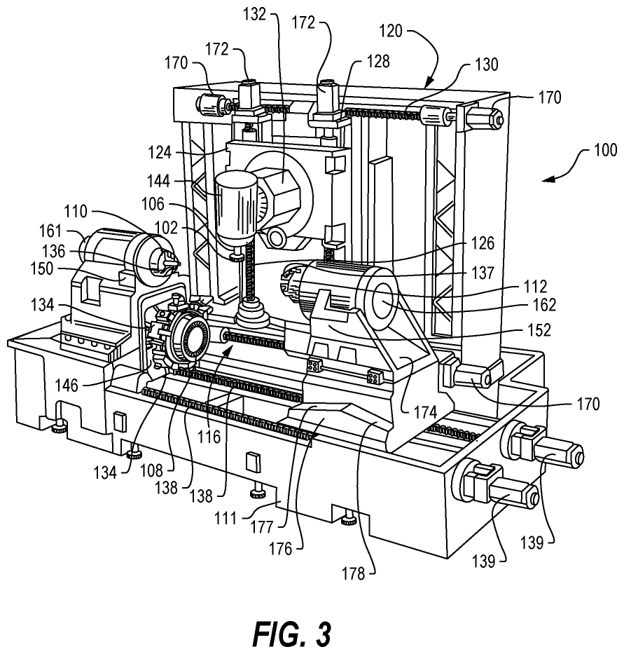

The spindle 144 is mounted on a carriage assembly 120 that allows for translational movement along the X- and Z-axis, and on a ram 132 that allows the spindle 144 to be moved in the Y-axis. The ram 132 is equipped with a motor to allow rotation of the spindle in the B-axis, as set forth in more detail below. As illustrated, the carriage assembly has a first carriage 124 that rides along two threaded vertical rails (one rail shown at 126) to cause the first carriage 124 and spindle 144 to translate in the X-axis. The carriage assembly also includes a second carriage 128 that rides along two horizontally disposed threaded rails (one shown in FIG. 3 at 130) to allow movement of the second carriage 128 and spindle 144 in the Z-axis. Each carriage 124, 128 engages the rails via plural ball screw devices whereby rotation of the rails 126, 130 causes translation of the carriage in the X- or Z-direction respectively. The rails are equipped with motors 170 and 172 for the horizontally disposed and vertically disposed rails respectively.

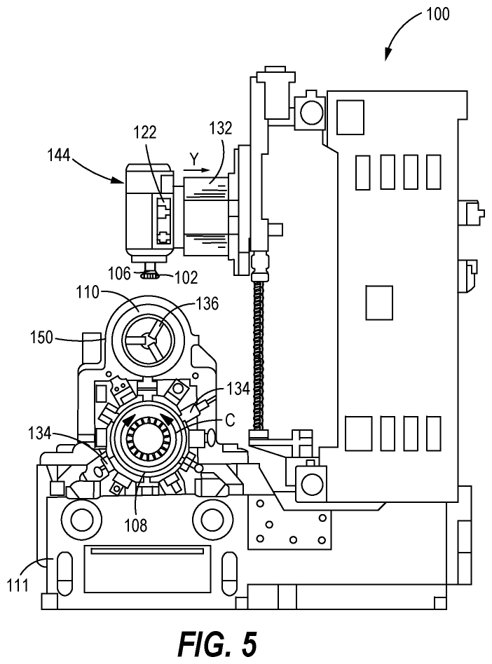

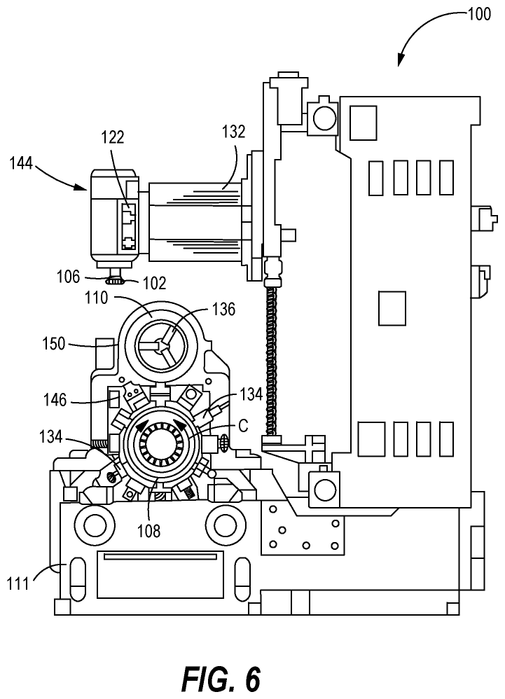

The spindle 144 holds the tool 102 by way of a spindle connection and a tool retainer 106. The spindle connection 145 (shown in FIG. 2) is connected to the spindle 144 and is contained within the spindle 144. The tool retainer 106 is connected to the spindle connection and holds the tool 102. Various types of spindle connections are known in the art and can be used with the computer numerically controlled machine 100. Typically, the spindle connection is contained within the spindle 144 for the life of the spindle. An access plate 122 for the spindle 144 is shown in FIGS. 5 and 6.

The first chuck 110 is provided with jaws 136 and is disposed in a stock 150 that is stationary with respect to the base 111 of the computer numerically controlled machine 100. The second chuck 112 is also provided with jaws 137, but the second chuck 112 is movable with respect to the base 111 of the computer numerically controlled machine 100. More specifically, the machine 100 is provided with threaded rails 138 and motors 139 for causing translation in the Z-direction of the second stock 152 via a ball screw mechanism as heretofore described. To assist in swarf removal, the second stock 152 is provided with a sloped distal surface 174 and a side frame 176 with Z-sloped surfaces 177, 178. Hydraulic controls and associated indicators for the chucks 110, 112 may be provided, such as the pressure gauges 182 and control knobs 184 shown in FIGS. 1 and 2. Each stock is provided with a motor (161, 162 respectively) for causing rotation of the chuck.

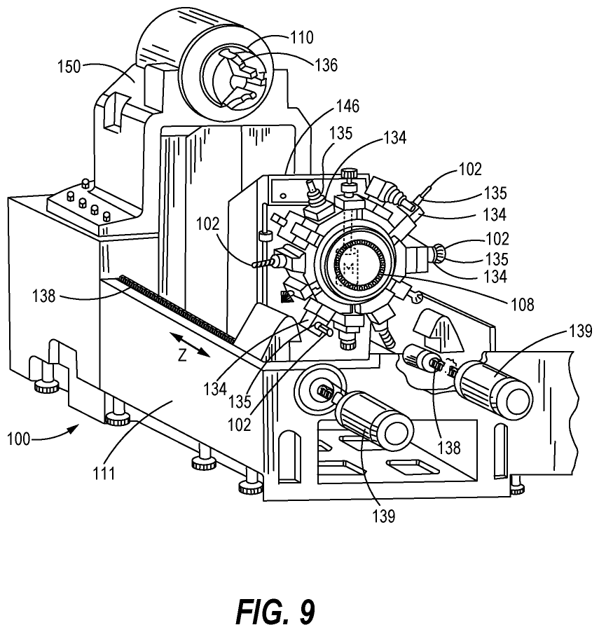

The turret 108, which is best depicted in FIGS. 5, 6 and 9, is mounted in a turret stock 146 (FIG. 5) that also engages rails 138 and that may be translated in a Z-direction, again via ball-screw devices. The turret 108 is provided with various turret connectors 134, as illustrated in FIG. 9. Each turret connector 134 can be connected to a tool retainer 135 or other connection for connecting to a tool. Since the turret 108 can have a variety of turret connectors 134 and tool retainers 135, a variety of different tools can be held and operated by the turret 108. The turret 108 may be rotated in a C′ axis to present different ones of the tool retainers (and hence, in many embodiments, different tools) to a workpiece.

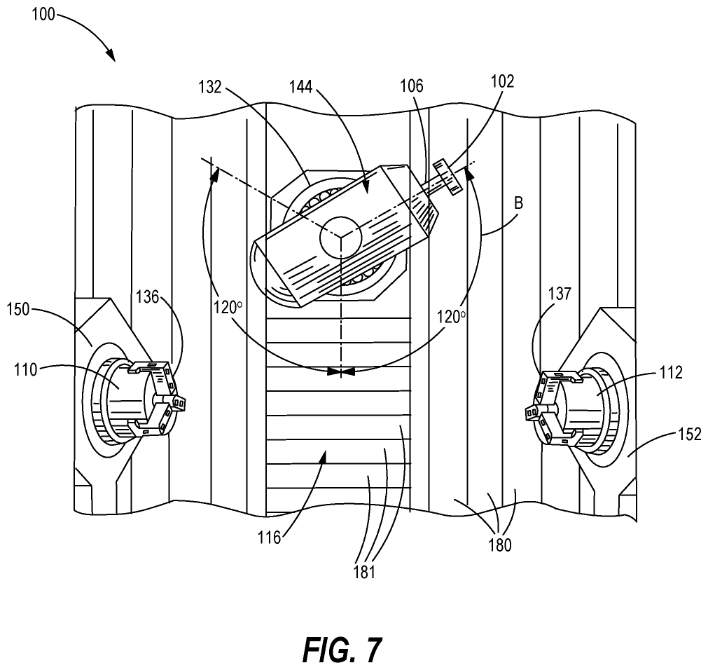

It is thus seen that a wide range of versatile operations may be performed. With reference to tool 102 held in tool retainer 106, such tool 102 may be brought to bear against a workpiece (not shown) held by one or both of chucks 110, 112. When it is necessary or desirable to change the tool 102, a replacement tool 102 may be retrieved from the tool magazine 142 by means of the tool changer 143. With reference to FIGS. 4 and 5, the spindle 144 may be translated in the X and Z directions (shown in FIG. 4) and Y direction (shown in FIGS. 5 and 6). Rotation in the B axis is depicted in FIG. 7, the illustrated embodiment permitting rotation within a range of 120 degrees to either side of the vertical. Movement in the Y direction and rotation in the B axis are powered by motors (not shown) that are located behind the carriage 124.

Generally, as seen in FIGS. 2 and 7, the machine is provided with a plurality of vertically disposed leaves 180 and horizontal disposed leaves 181 to define a wall of the machine chamber 116 and to prevent swarf from exiting this chamber.

The components of the machine 100 are not limited to the heretofore described components. For instance, in some instances an additional turret may be provided. In other instances, additional chucks and/or spindles may be provided. Generally, the machine is provided with one or more mechanisms for introducing a cooling liquid into the machine chamber 116.

In the illustrated embodiment, the computer numerically controlled machine 100 is provided with numerous retainers. Chuck 110 in combination with jaws 136 forms a retainer, as does chuck 112 in combination with jaws 137. In many instances these retainers will also be used to hold a workpiece. For instance, the chucks and associated stocks will function in a lathe-like manner as the headstock and optional tailstock for a rotating workpiece. Spindle 144 and spindle connection 145 form another retainer. Similarly, the turret 108, when equipped with plural turret connectors 134, provides a plurality of retainers (shown in FIG. 9).

The computer numerically controlled machine 100 may use any of a number of different types of tools known in the art or otherwise found to be suitable. For instance, the tool 102 may be a cutting tool such as a milling tool, a drilling tool, a grinding tool, a blade tool, a broaching tool, a turning tool, or any other type of cutting tool deemed appropriate in connection with a computer numerically controlled machine 100. Additionally or alternatively, the tool may be configured for an additive manufacturing technique, as discussed in greater detail below. In either case, the computer numerically controlled machine 100 may be provided with more than one type of tool, and via the mechanisms of the tool changer 143 and tool magazine 142, the spindle 144 may be caused to exchange one tool for another. Similarly, the turret 108 may be provided with one or more tools 102, and the operator may switch between tools 102 by causing rotation of the turret 108 to bring a new turret connector 134 into the appropriate position.

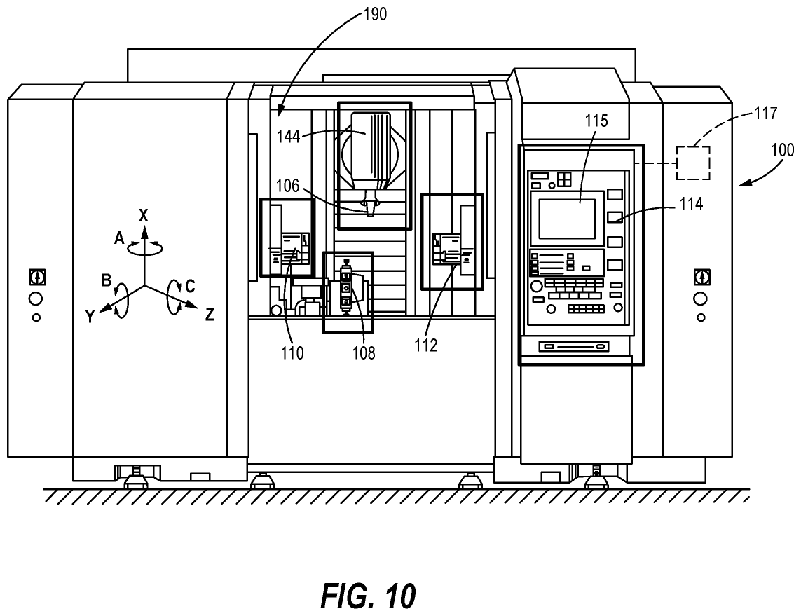

The computer numerically controlled machine 100 is illustrated in FIG. 10 with the safety doors open. As shown, the computer numerically controlled machine 100 may be provided with at least a tool retainer 106 disposed on a spindle 144, a turret 108, one or more chucks or workpiece retainers 110, 112 as well as a user interface 114 configured to interface with a computer control system of the computer numerically controlled machine 100. Each of the tool retainer 106, spindle 144, turret 108 and workpiece retainers 110, 112 may be disposed within a machining area 190 and selectively rotatable and/or movable relative to one another along one or more of a variety of axes.

As indicated in FIG. 10, for example, the X, Y, and Z axes may indicate orthogonal directions of movement, while the A, B, and C axes may indicate rotational directions about the X, Y, and Z axes, respectively. These axes are provided to help describe movement in a three-dimensional space, and therefore, other coordinate schemes may be used without departing from the scope of the appended claims. Additionally, use of these axes to describe movement is intended to encompass actual, physical axes that are perpendicular to one another, as well as virtual axes that may not be physically perpendicular but in which the tool path is manipulated by a controller to behave as if they were physically perpendicular.

With reference to the axes shown in FIG. 10, the tool retainer 106 may be rotated about a B-axis of the spindle 144 upon which it is supported, while the spindle 144 itself may be movable along an X-axis, a Y-axis and a Z-axis. The turret 108 may be movable along an XA-axis substantially parallel to the X-axis and a ZA-axis substantially parallel to the Z axis. The workpiece retainers 110, 112 may be rotatable about a C-axis, and further, independently translatable along one or more axes relative to the machining area 190. While the computer numerically controlled machine 100 is shown as a six-axis machine, it is understood that the number of axes of movement is merely exemplary, as the machine may be capable of movement in less than or greater than six axes without departing from the scope of the claims.

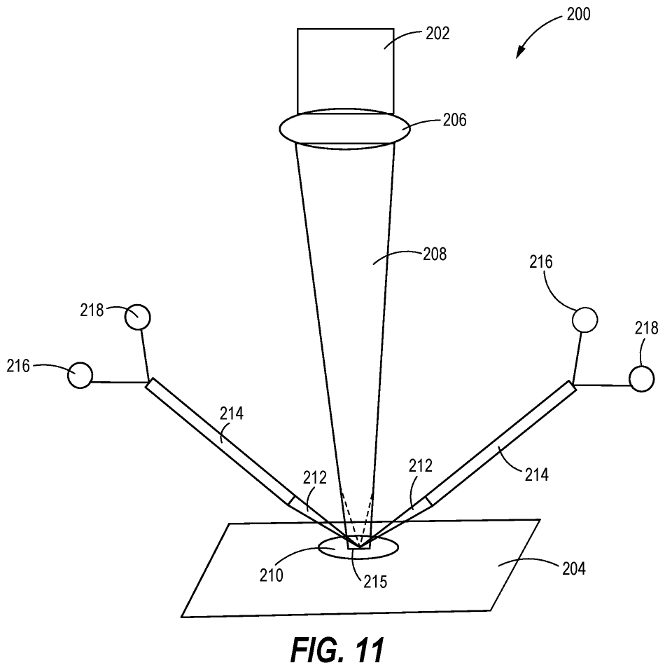

The computer numerically controlled machine 100 may include a material deposition assembly for performing additive manufacturing processes. An exemplary material deposition assembly 200 is schematically illustrated in FIG. 11 as including an energy beam 202 capable of being directed toward a substrate 204. The material deposition assembly 200 may be used in, for example, directed energy deposition. The substrate 204 may be supported by one or more of the workpiece retainers, such as chucks 110, 112. The material deposition assembly 200 may further include an optic 206 that may direct a concentrated energy beam 208 toward the substrate 204, however the optic 206 may be omitted if the concentrated energy beam 208 has sufficiently large energy density. The energy beam 202 may be a laser beam, an electron beam, an ion beam, a cluster beam, a neutral particle beam, a plasma jet, or a simple electrical discharge (arc). The concentrated energy beam 208 may have an energy density sufficient to melt a small portion of the growth surface substrate 204, thereby forming a melt-pool 210, without losing substrate material due to evaporation, splattering, erosion, shock-wave interactions, or other dynamic effects. The concentrated energy beam 208 may be continuous or intermittently pulsed.

The melt-pool 210 may include liquefied material from the substrate 204 as well as additive material. In an exemplary embodiment, the additive material may be provided as a feed powder that is directed onto the melt-pool 210 in a feed powder/propellant gas mixture 212 exiting one or more nozzles 214. The nozzles 214 may fluidly communicate with a feed powder reservoir 216 and a propellant gas reservoir 218. The nozzles 214 create a flow pattern of feed powder/propellant gas mixture 212 that may substantially converge into an apex 215 or region of smallest physical cross-section so that the feed powder is incorporated into the melt-pool 210. As the material deposition assembly 200 is moved relative to the substrate 204, the assembly traverses a tool path that forms a bead layer on the substrate 204. Additional bead layers may be formed adjacent to or on top of the initial bead layer to fabricate solid, three-dimensional objects.

While the illustrated embodiment shows the additive material in the form of a powder, it may take other forms. For example, the additive material may be provided as a wire feed material, a foil material, or any other type of material known for use in additive manufacturing processes.

Depending on the materials used and the object tolerances required, it is often possible to form net shape objects, or objects which do not require further machining for their intended application (polishing and the like are permitted). Should the required tolerances be more precise than are obtainable by the material deposition assembly 200, a subtractive finishing process may be used. When additional finishing machining is needed, the object generated by the material deposition assembly 200 prior to such finishing is referred to herein as “near-net shape” to indicate that little material or machining is needed to complete the fabrication process.

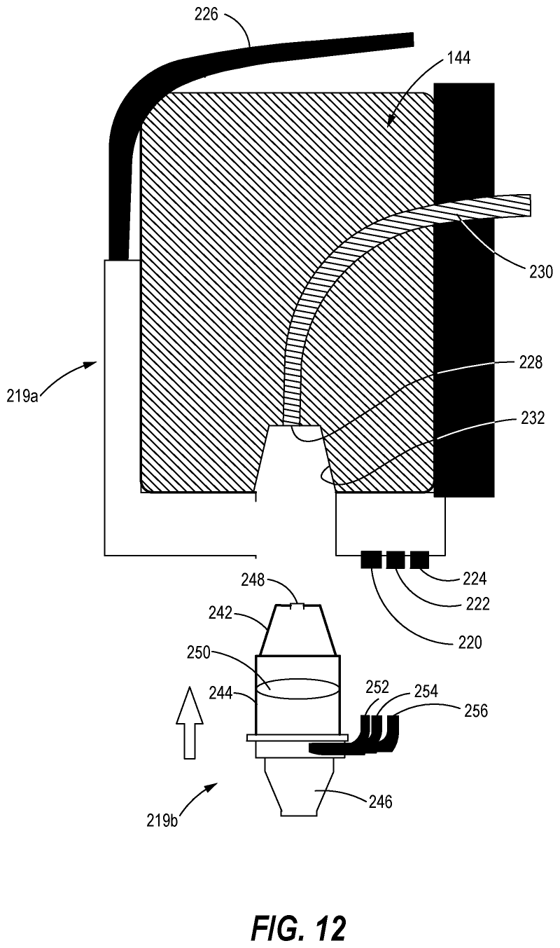

The material deposition assembly 200 may be incorporated into the computer numerically controlled machine 100, as best shown in FIG. 12. In this exemplary embodiment, the material deposition assembly 200 includes a processing head assembly 219 having an upper processing head 219a and a lower processing head 219b. The lower processing head 219b is detachably coupled to the upper processing head 219a to permit the upper processing head 219a to be used with different lower processing heads 219b. The ability to change the lower processing head 219b may be advantageous when different deposition characteristics are desired, such as when different shapes and/or densities of the energy beam 202 and/or feed powder/propellant gas mixture 212 are needed.

More specifically, the upper processing head 219a may include the spindle 144. A plurality of ports may be coupled to the spindle 144 and are configured to interface with the lower processing head 219b when connected. For example, the spindle 144 may carry a feed powder/propellant port 220 fluidly communicating with a powder feed supply (not shown), which may include a feed powder reservoir and a propellant reservoir. Additionally, the spindle 144 may carry a shield gas port 222 fluidly communicating with a shield gas supply (not shown), and a coolant port 224 fluidly communicating with a coolant supply (not shown). The feed powder/propellant port 220, shield gas port 222, and coolant port 224 may be connected to their respective supplies either individually or through a harnessed set of conduits, such as conduit assembly 226.

The upper processing head 219a further may include a fabrication energy port 228 operatively coupled to a fabrication energy supply (not shown). In the illustrated embodiment, the fabrication energy supply is a laser connected to the fabrication energy port 228 by laser fiber 230 extending through a housing of the spindle 144. The laser fiber 230 may travel through a body of the spindle 144, in which case the fabrication energy port 228 may be located in a socket 232 formed in a bottom of the spindle 144. Therefore, in the embodiment of FIG. 12, the fabrication energy port 228 is disposed inside the socket 232 while the feed powder/propellant port 220, shield gas port 222, and coolant port 224 are disposed adjacent the socket 232. The upper processing head 219a may further include additional optics for shaping the energy beam, such as a collimation lens, a partially reflective mirror, or a curved mirror.

The upper processing head 219a may be selectively coupled to one of a plurality of lower processing heads 219b. As shown in FIG. 12, an exemplary lower processing head 219b may generally include a base 242, an optic chamber 244, and a nozzle 246. Additionally, a nozzle adjustment assembly may be provided to translate, rotate, or otherwise adjust the position and/or orientation of the nozzle 246 relative to the energy beam. The base 242 is configured to closely fit inside the socket 232 to permit releasable engagement between the lower processing head 219b and the upper processing head 219a. In the embodiment of FIG. 12, the base 242 also includes a fabrication energy interface 248 configured to detachably couple to the fabrication energy port 228. The optic chamber 244 may be either empty or it may include a final optic device, such as a focusing optic 250 configured to provide the desired concentrated energy beam. The lower processing head 219b may further include a feed powder/propellant interface 252, a shield gas interface 254, and a coolant interface 256 configured to operatively couple with the feed powder/propellant port 220, shield gas port 222, and coolant port 224, respectively.

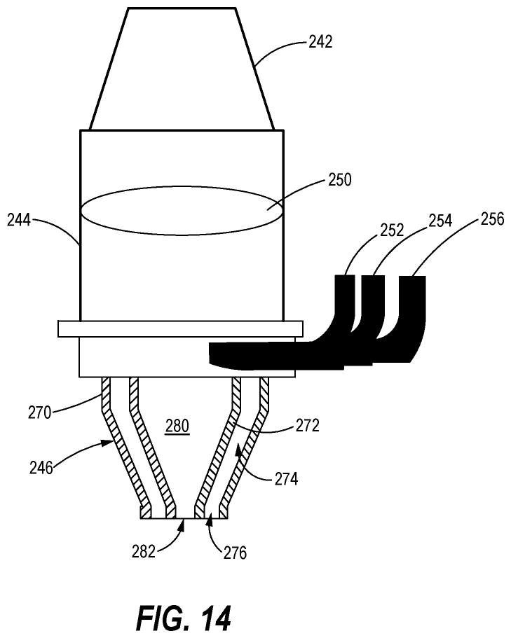

The nozzle 246 may be configured to direct feed powder/propellant toward the desired target area. In the embodiment illustrated at FIG. 14, the nozzle 246 includes an outer nozzle wall 270 spaced from an inner nozzle wall 272 to define a powder/propellant chamber 274 in the space between the outer and inner nozzle walls 270, 272. The powder/propellant chamber 274 fluidly communicates with the feed powder/propellant interface 252 at one end and terminates at an opposite end in a nozzle exit orifice 276. In the exemplary embodiment, the nozzle exit orifice 276 has an annular shape; however other the nozzle exit orifice 276 may have other shapes without departing from the scope of the present disclosure. The powder/propellant chamber 274 and nozzle exit orifice 276 may be configured to provide one or more jets of feed powder/propellant at the desired angle of convergence. The nozzle 246 of the illustrated embodiment may deliver a single, conical-shaped jet of powder/propellant gas. It will be appreciated, however, that the nozzle exit orifice 276 may be configured to provide multiple discrete jets of powder/propellant gas. Still further, the resulting jet(s) of powder/propellant gas may have shapes other than conical.

The nozzle 246 may further be configured to permit the energy beam to pass through the nozzle 246 as it travels toward the target area. As best shown in FIG. 14, the inner nozzle wall 272 defines a central chamber 280 having a fabrication energy outlet 282 aligned with the optic chamber 244 and the optional focusing optic 250. Accordingly, the nozzle 246 permits the beam of fabrication energy to pass through the nozzle 246 to exit the lower processing head 219b.

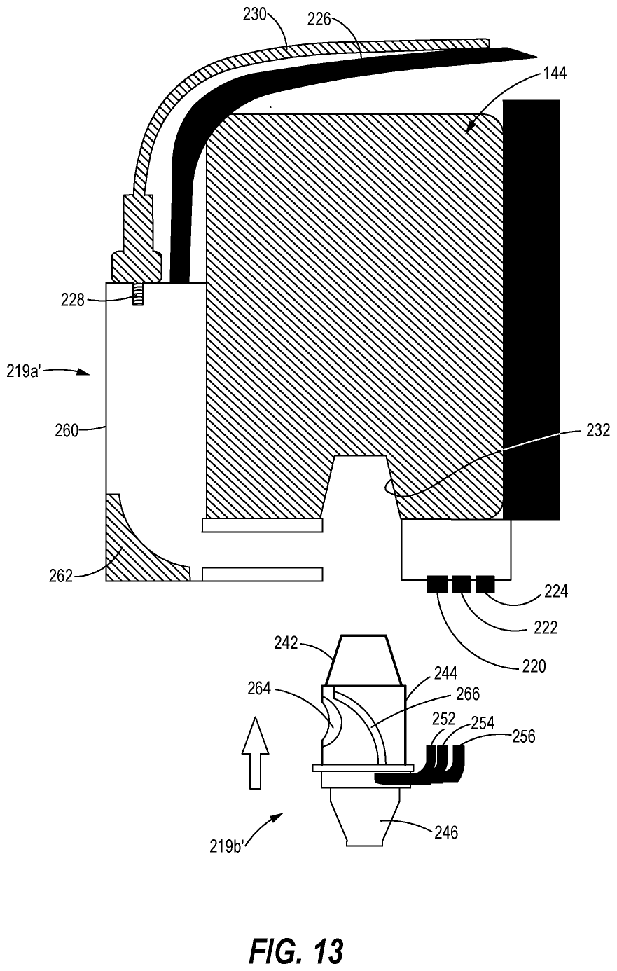

In an alternative embodiment, an upper processing head 219a′ may have the fabrication energy port 228 provided outside of the housing of the spindle 144 as best shown in FIG. 13. In this embodiment, the fabrication energy port 228 is located on an enclosure 260 provided on a side of the spindle 144, and therefore, unlike the above embodiment, this port is not provided in the socket 232. The enclosure 260 includes a first mirror 262 for directing the fabrication energy toward a point below the socket 232 of the spindle 144. An alternative lower processing head 219b′ includes an optic chamber 244 that includes a fabrication energy receptacle 264 through which the fabrication energy may pass from the enclosure 260 to an interior of the optic chamber 244. The optic chamber 244 further includes a second mirror 266 for redirecting the fabrication energy through the nozzle 246 and toward the desired target location.

While the exemplary embodiments incorporate the fabrication energy into the processing head assembly 219, it will be appreciated that the fabrication energy may be provided independent of the processing head assembly 219. That is, a separate assembly, such as the turret 108, the first chuck 110, the second chuck 112, or a dedicated robot provided with the machine 100, may be used to direct the fabrication energy toward the substrate 204. In this alternative embodiment, the processing head assembly 219 would omit the fabrication energy port, fabrication energy interface, fabrication energy outlet, optic chamber, and focusing optic.

With the processing head assembly 219 having the upper processing head 219a configured to selectively couple with any one of several lower processing heads 219b, the computer numerically controlled machine 100 may be quickly and easily reconfigured for different additive manufacturing techniques. The tool magazine 142 may hold a set of lower processing heads 219b, wherein each lower processing head in the set has unique specifications suited for a particular additive manufacturing process. For example, the lower processing heads may have different types of optics, interfaces, and nozzle angles that alter the manner in which material is deposited on the substrate or energy is directed to the target area. When a particular part must be formed using different additive manufacturing techniques (or may be formed more quickly and efficiently when multiple different techniques are used), the tool changer 143 may be used to quickly and easily change the particular deposition head coupled to the spindle 144. In the exemplary embodiments illustrated in FIGS. 12 and 13, a single attachment step may be used to connect the energy, feed powder/propellant gas, shield gas, and coolant supplies to the deposition head. Similarly, detachment is accomplished in a single disconnect step. Accordingly, the machine 100 may be more quickly and easily modified for different material deposition techniques.

In certain additive manufacturing applications, it may be advantageous to control a rate at which the additive material solidifies, which is referred to herein as the solidification rate, when working with certain materials and/or build object geometries. Nickel-based and high strength materials intended for extreme environments, such as Inconel 718, may be susceptible to volume change of the deposited layer during a build, which can lead to warping, compromised dimensional integrity of the build, and increased surface roughness. By controlling the solidification rate, these issues can be mitigated.

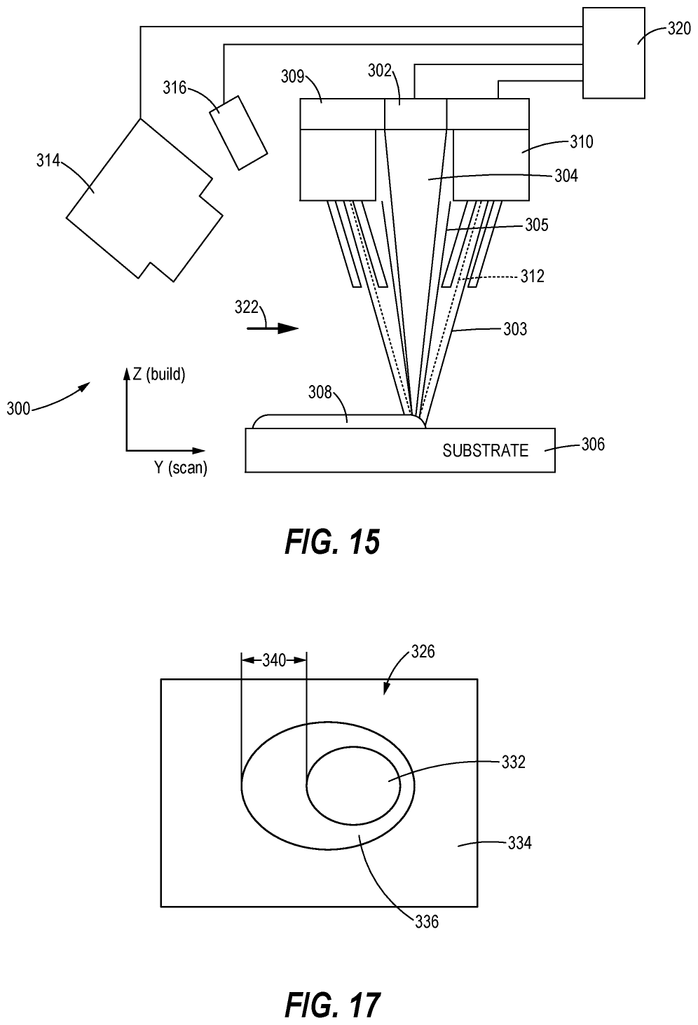

An exemplary embodiment of an additive manufacturing apparatus 300 capable of controlling solidification rate of a melt pool 308 is illustrated at FIG. 15. The additive manufacturing apparatus 300 includes an energy source 302 configured to direct an energy beam 304 onto a substrate 306, thereby to form the melt pool 308. In some embodiments, the energy source 302 is a laser. A nozzle 310 is configured to deposit additive material, such as powder 312, into the melt pool 308. The nozzle 310 may also deliver a carrier gas 303 for directing the powder 312 toward the melt pool 308. A shield gas 305 may also be provided for isolating the energy beam 304 from the powder 312 before the powder 312 reaches the melt pool 308. The energy source 302 and nozzle 310 may be incorporated into the computer numerically controlled machine 100 and supported for movement relative to the substrate 306. For example, the energy source 302 and nozzle 310 may be supported by the spindle 144. Alternatively, when the apparatus 300 is provided independently from the machine 100, the energy source 302 and nozzle 310 may be supported by a movable deposition support 309, such as a robot arm.

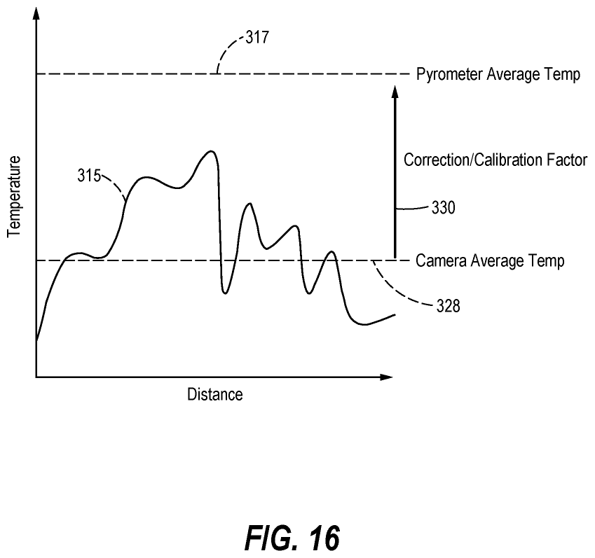

The apparatus 300 includes a camera 314 for measuring energy emitted by the melt pool 308. In an exemplary embodiment, the camera 314 is configured to measure infrared energy, however a camera capable of detecting energy in other wavelengths, such as near IR, may be used. Alternatively, the camera 314 may be provided as a Charge-Coupled Device (CCD) or Complementary Metal-Oxide-Semiconductor (CMOS) camera. The camera 314 is capable of measuring an apparent thermal signature 315 (illustrated in graph form in FIG. 16) of the melt pool 308, which identifies areas of relatively higher or lower temperatures within the melt pool 308.

The apparatus 300 may optionally include a device for measuring actual temperature, such as a pyrometer 316. The pyrometer 316 measures an average actual temperature 317 (illustrated in graph form in FIG. 16) of the melt pool 308. In alternative embodiments, the pyrometer 316 may be replaced by a thermocouple (which may require using back calculations to arrive at the average actual temperature 317), or the average actual temperature 317 may be derived using simulation.

The camera 314 and pyrometer 316 are illustrated in FIG. 15 as being offset from the energy source 302, suggesting the use of independent optic chains for these devices. Alternatively, the camera 314 and pyrometer 316 may be positioned to share the same optics chain as the energy source 302. For example, the camera 314 and pyrometer 316 are oriented to measure temperature of the melt pool along an optics path that travels through the nozzle 310.

A controller 320 is operatively coupled to the energy source 302, camera 314, and pyrometer 307. In embodiments where the apparatus 300 is incorporated into the computer numerically controlled machine 100, the controller 320 may be incorporated into the computer control system 113, in which case the controller 320 is further operatively coupled to the spindle 144 or other tool holder supporting the energy source 302 and nozzle 310. Alternatively, the apparatus 300 may be provided independently of the machine 100, in which case the controller 320 is dedicated to the apparatus 300 and is further operatively coupled to the movable deposition support 309.

The controller 320 is programmed to move the move the energy source 302 relative to the substrate 306. During relative movement, the energy beam 304 traverses over the substrate 306 in a process direction (represented by arrow 322 in FIG. 15) and at a process speed. As the energy source 302 moves, the nozzle 310 deposits additive material into the melt pool 308 to form a track 324 of additive material. The controller 320 receives a signal from the camera 314 from which it determines the apparent thermal signature 315 of the melt pool 308 based on the energy of the melt pool 308.

In some embodiments, the controller 320 further may be programmed to apply a correction factor 330 to the apparent thermal signature 315, thereby to obtain a corrected thermal signature 326 as best shown in FIG. 17. First, the controller 320 may calculate an average apparent temperature 328 (illustrated in graph form in FIG. 16) of the apparent thermal signature 315. Then, the controller 320 may compare the average apparent temperature 328 to the average actual temperature 317 to derive a correction factor 330. In the illustrated embodiment, the correction factor 330 is the difference between the average apparent temperature 328 and the average actual temperature 317. Alternatively, the correction factor 330 may be proportional to the difference between the average apparent temperature 328 and the average actual temperature 317. Still further, a coefficient may be developed that is indicative an emissivity curve for the additive material being deposited, and that coefficient may be applied to the difference between the average apparent temperature 328 and the average actual temperature 317. The correction factor 330 may then be applied to the apparent thermal signature 315 to obtain the corrected thermal signature 326 of the melt pool 308. The corrected thermal signature 326 more accurately depicts the actual temperate in the melt pool 308.

The controller 320 may further categorize regions of the melt pool 308 based on either the apparent thermal signature 315 or the corrected thermal signature 326. In an exemplary embodiment illustrated in FIG. 17, a liquidus region 332 of the melt pool 308 is identified as the area where the temperature is at least the lowest temperature at which the additive material is liquid. Additionally, a solidus region 334 may surround the melt pool 308, and is identified as the area where the temperature is no greater than the highest temperature at which the additive material is solid. Still further, the controller 320 may further identify an transitional region 336 of the melt pool 308 that is present between the liquidus region 332 and the solidus region 334, where temperatures are between the liquidus region temperature threshold and the solidus region temperature threshold. It is noted that while the temperature thresholds may be the same for pure substances, they can be different for alloys, such as Inconel 718.

After categorizing the regions of the melt pool 308, the controller 320 may then quantify a physical parameter of the transitional region 336. The physical parameter to be quantified may be any measurable aspect of the transitional region 336 that is indicative of an actual solidification rate of the additive material. For example, the physical parameter may be a solidification distance 340 measured through the transitional region 336 and in the process direction 322, as best shown in FIG. 17. Alternatively, the physical parameter may be a ratio of an area of the transitional region 336 to an area of the melt pool 308.

With the physical parameter of the transitional region 336 quantified, the controller 320 may determine an actual solidification rate based on a comparison of the physical parameter of the transitional region 336 and the process speed. Solidification rate is defined herein as the period of time it takes for the additive material to cool from the liquidus temperature to the solidus temperature. Where the physical parameter is the solidification distance 340, for example, the controller 320 may be programmed to determine the actual solidification rate as being proportional to the solidification distance 340 divided by the process speed. Where the physical parameter is the ratio of the area of the transitional region 336 to the area of the melt pool 308, the controller 320 may be programmed to determine the actual solidification rate as being proportional to the ratio divided by the process speed.

Based on the actual solidification rate, the controller 320 may adjust a process parameter associated with the additive manufacturing process to change the solidification rate of the additive material deposited into the melt pool 308. For example, the controller 320 may be programmed to adjust a power level of the energy beam 304, adjust a rate at which additive material (such as powder 312) is deposited into the melt pool 308, adjust the process speed, incorporate a dwell time, or adjust a temperature of the substrate 306 (when the substrate 306 is an active cooling substrate). Furthermore, any combination of the above adjustments may be made simultaneously to obtain a desired solidification rate of the additive material.

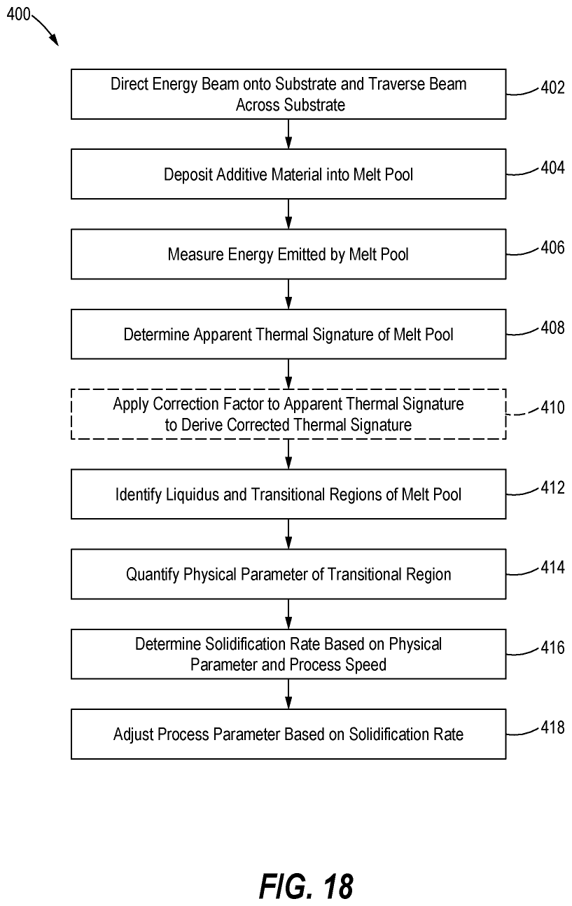

Turning now to FIG. 18, an exemplary method 400 for additive manufacturing a build object is illustrated in a block diagram. The method 400 may utilize any of the aforementioned systems, method, and apparatus described above, including any and all elements associated with or part of the machine 100. The method 400 may be specifically configured to accurately determine an actual solidification rate of the additive material in situ, and use the actual solidification rate to adjust one or more process parameters, thereby changing the solidification rate as desired. In an alternative embodiment, the method 400 also includes applying the correction factor 330 to the apparent thermal signature 315.

At block 402 of method 400, an energy beam 304 is directed onto the substrate 306 to form a melt pool 308 on the substrate 204, wherein the energy beam 304 traverses the substrate 306 in a process direction 322 at a process speed. As noted above, the energy beam 304 may be a laser beam directed through an optic 206 to form the melt pool 308 with the desired shape and size. Movement of the energy beam 304 may be via computer numerically controlled machine 100 or via a movable deposition support 309, such as a robot arm, provided either with or independently of the machine 100.

The method 400 continues at block 404, where additive material is deposited into the melt pool 308. In the illustrated embodiment, the additive material is provided in powder 312 form that is delivered through a nozzle 310 by a carrier gas.

At block 406, the method 400 includes measuring energy emitted by the melt pool 308. Energy measurement may be taken at any wavelength, such as IR, near-IR, or other wavelength. Devices suitable for measuring the energy emitted by the melt pool 308 include an IR camera, CCD camera, or CMOS camera.

At block 408, the method 400 determines an apparent thermal signature 315 of the melt pool 308 based on the measured energy from block 406. The apparent thermal signature 315 identifies areas of relatively higher and lower temperatures within the melt pool 308. The device used in block 406, such as the IR camera, may be configured to generate the apparent thermal signature 315, or it may be capable of delivering a signal to the controller 320 indicative of the apparent thermal signature 315.

Next, in an optional step identified by block 410 of the method 400, a correction factor 330 is applied to the apparent thermal signature 315 to arrive at a corrected thermal signature 326. Applying the correction factor 330 may include calculating an average apparent temperature 328, determining an average actual temperature 317 of the melt pool 308, and determining a correction factor 330 based on a comparison of the average apparent temperature 328 and the average actual temperature 317. The correction factor 330 is then applied to the apparent thermal signature 315 to obtain the corrected thermal signature 326 of the melt pool 308.

The method 400 continues at block 412 by identifying a liquidus region 332 of the melt pool 308, a solidus region 334 surrounding the melt pool 308, and an transitional region 336 of the melt pool 308 that extends between the liquidus region 332 and the solidus region 334 based. Identification of the different regions may be based on either the apparent thermal signature 315 or the corrected thermal signature 326.

At block 414, a physical parameter of the transitional region 336 of the melt pool 308 is quantified. As noted above, the physical parameter may be any measurable aspect of the transitional region 336 that is indicative of an actual solidification rate of the additive material. For example, the physical parameter may be a solidification distance 340 measured through the transitional region 336 and in the process direction 322, as best shown in FIG. 17. Alternatively, the physical parameter may be a ratio of an area of the transitional region 336 to an area of the melt pool 308.

At block 416, the method 400 determines an actual solidification rate based on a comparison of the physical parameter of the transitional region 336 and the process speed. Where the physical parameter is the solidification distance 340, for example, the controller 320 may be programmed to determine the actual solidification rate as being proportional to the solidification distance 340 divided by the process speed. Where the physical parameter is the ratio of the area of the transitional region 336 to the area of the melt pool 308, the controller 320 may be programmed to determine the actual solidification rate as being proportional to the ratio divided by the process speed.

Finally, at block 418, the method 400 continues by adjusting a process parameter based on the actual solidification rate to achieve a desired solidification rate. For example, the controller 320 may be programmed to adjust a power level of the energy beam 304, adjust a rate at which additive material (such as powder 312) is deposited into the melt pool 308, adjust the process speed, incorporate a dwell time, or adjust a temperature of the substrate 306 (when the substrate 306 is an active cooling substrate). Furthermore, any combination of the above adjustments may be made simultaneously to obtain a desired solidification rate of the additive material.

### INDUSTRIAL APPLICABILITY

The methods and apparatus disclosed herein may be used to improve additive manufacturing processes. During certain types of additive manufacturing applications, such as when working with certain materials and/or build object geometries, it may be advantageous to control a rate at which the additive material solidifies. For example, nickel-based and high strength materials intended for extreme environments, such as Inconel 718, may be susceptible to volume change of the deposited layer during a build, leading to warping, compromised dimensional integrity of the build, and increased surface roughness. These issues can be mitigated by accurately determining an actual solidification rate and adjusting processing parameters to achieve a desired solidification rate.

All references, including publications, patent applications, and patents, cited herein are hereby incorporated by reference. The description of certain embodiments as “preferred” embodiments, and other recitation of embodiments, features, or ranges as being preferred, is not deemed to be limiting, and the claims are deemed to encompass embodiments that may presently be considered to be less preferred. All methods described herein can be performed in any suitable order unless otherwise indicated herein or otherwise clearly contradicted by context. The use of any and all examples, or exemplary language (e.g., “such as”) provided herein, is intended to illuminate the disclosed subject matter and does not pose a limitation on the scope of the claims. Any statement herein as to the nature or benefits of the exemplary embodiments is not intended to be limiting, and the appended claims should not be deemed to be limited by such statements. More generally, no language in the specification should be construed as indicating any non-claimed element as being essential to the practice of the claimed subject matter. The scope of the claims includes all modifications and equivalents of the subject matter recited therein as permitted by applicable law. Moreover, any combination of the above-described elements in all possible variations thereof is encompassed by the claims unless otherwise indicated herein or otherwise clearly contradicted by context. The description herein of any reference or patent, even if identified as “prior,” is not intended to constitute a concession that such reference or patent is available as prior art against the present disclosure.

1. A method of forming a three-dimensional build object on a substrate, comprising:
directing an energy beam onto the substrate to form a melt pool on the substrate, wherein the energy beam traverses the substrate in a process direction at a process speed;
depositing additive material into the melt pool;
measuring energy emitted by the melt pool;
determining a thermal signature of the melt pool based on the measured energy;
identifying a liquidus region of the melt pool, a solidus region surrounding the melt pool, and a transitional region of the melt pool based on the thermal signature;
quantifying a physical parameter of the transitional region of the melt pool;
determining an actual solidification rate based on a comparison of the physical parameter of the transitional region and the process speed; and
adjusting a process parameter based on the actual solidification rate.

2. The method of claim 1, in which:
determining the thermal signature of the melt pool comprises determining an apparent thermal signature of the melt pool; and
identifying the liquidus, solidus, and transitional regions comprises identifying the liquidus, solidus, and transitional regions based on the apparent thermal signature of the melt pool.

3. The method of claim 1, in which determining the thermal signature of the melt pool comprises determining an apparent thermal signature of the melt pool, the method further comprising:
determining an average actual temperature of the melt pool;
calculating an average apparent temperature of the apparent thermal signature;
determining a correction factor based on a comparison of the average apparent temperature and the average actual temperature; and
applying the correction factor to the apparent thermal signature to obtain a corrected thermal signature of the melt pool;
wherein identifying the liquidus, solidus, and transitional regions comprises identifying liquidus, solidus, and transitional regions based on the corrected thermal signature of the melt pool.

4. The method of claim 3, in which the correction factor is proportional to a difference between the average apparent temperature and the average actual temperature.

5. The method of claim 3, in which determining the average actual temperature of the melt pool comprises directing a pyrometer at the melt pool.

6. The method of claim 5, in which the pyrometer comprises a dual-wavelength pyrometer, and in which determining the average actual temperature of the melt pool comprises determining a first energy profile at a first wavelength, determining a second energy profile at a second wavelength, and calculating the average actual temperature based on a ratio of the first energy profile to the second energy profile.

7. The method of claim 1, in which quantifying the physical parameter of the transitional region of the melt pool comprises determining a ratio of an area of the transitional region to an area of the sum of the transitional and liquidus regions.

8. Additive manufacturing apparatus for forming a three-dimensional build object on a substrate, the apparatus comprising:
an energy source configured to direct an energy beam onto the substrate to form a melt pool on the substrate;
a nozzle configured to deposit additive material into the melt pool;
a camera configured to measure energy emitted by the melt pool; and
a controller operatively coupled to the energy source and camera, the controller programmed to:
move the energy source so that the energy beam traverses over the substrate in a process direction at a process speed;
determine a thermal signature of the melt pool based on the energy of the melt pool measured by the camera;
identify a liquidus region of the melt pool, a solidus region surrounding the melt pool, and an transitional region of the melt pool between the liquidus region and the solidus region based on the thermal signature;
quantify a physical parameter of the transitional region of the melt pool;
determine an actual solidification rate based on a comparison of the physical parameter of the transitional region and the process speed; and
adjust a process parameter based on the actual solidification rate.

9. The apparatus of claim 8, in which the controller is further programmed to:
determine the thermal signature of the melt pool by determining an apparent thermal signature of the melt pool; and
identify the liquidus, solidus, and transitional regions based on the apparent thermal signature of the melt pool.

10. The apparatus of claim 8, further comprising a pyrometer configured to measure an average actual temperature of the melt pool.

11. The apparatus of claim 10, in which the controller is further programmed to:
determine the thermal signature of the melt pool by determining an apparent thermal signature of the melt pool;
calculate an average apparent temperature of the apparent thermal signature;
determine a correction factor based on a comparison of the average apparent temperature and the average actual temperature;
apply the correction factor to the apparent thermal signature to obtain a corrected thermal signature of the melt pool;
identify the liquidus, solidus, and transitional regions based on the corrected thermal signature of the melt pool.

12. The apparatus of claim 11, in which the controller is further programmed to determine the correction factor as proportional to a difference between the average apparent temperature and the average actual temperature.

13. The apparatus of claim 11, in which the pyrometer comprises a dual-wavelength pyrometer configured to determine a first energy profile of the melt pool at a first wavelength and to determine a second energy profile of the melt pool at a second wavelength, and in which the controller is further programmed to calculate the average actual temperature based on a ratio of the first energy profile to the second energy profile.
